(19) United States
(12) Patent Application Publication
(10) Pub. No.: US 2016/0046498 A1
(43) Pub. Date: Feb. 18, 2016

(54) PROCESS FOR STABILIZING HEAT EXCHANGER TUBES IN ANDRUSSOW PROCESS

(71) Applicant: INVISTA TECHNOLOGIES S.A.R.L., St. Gallen (CH)

(72) Inventors: John C. CATON, Yoakum, TX (US); Brent J. STAHLMAN, Victoria, TX (US); Rocky WANG, Port Lavaca, TX (US)

(73) Assignee: INVISTA NORTH AMERICA S.A R.L., Wilmington, DE (US)

(21) Appl. No.: 14/742,134

(22) PCT Filed: Dec. 12, 2013
(86) PCT No.: PCT/US13/74642

§ 371 Date: Jun. 17, 2015

Related U.S. Application Data
(60) Provisional application No. 61/738,775, filed on Dec. 18, 2012.

(51) Int. Cl. C01C 3/02

(52) U.S. Cl. CPC C01C 3/0212

(57) ABSTRACT

The present invention relates to an improved process for producing hydrogen cyanide involving a heat exchanger comprising a plurality of tubes, wherein each of the plurality of tubes comprises a ceramic ferrule extending through the entrance of the tube, each ferrule comprising an insulation layer surrounding at least a portion of the ferrule, and one or more washers, wherein at least one of the one or more washers surrounds the ferrule above the entrance of the tube, wherein the ceramic ferrule is spaced apart from the tube. It further relates to a reaction apparatus for producing hydrogen cyanide involving a heat exchanger comprising a plurality of tubes, wherein each of the plurality of tubes comprises a ceramic ferrule extending through the entrance of the tube, each ferrule comprising an insulation layer surrounding at least a portion of the ferrule, and one or more washers, wherein at least one of the one or more washers surrounds the ferrule above the entrance of the tube, wherein the ceramic ferrule is spaced apart from the tube. It further relates to the heat exchanger for use in this improved process and reaction apparatus.

### CROSS REFERENCE TO RELATED APPLICATION

This application claims priority to U.S. App. No. 61/738,775, filed Dec. 18, 2012, the entire contents and disclosures of which are incorporated herein.

### FIELD OF THE INVENTION

The present invention relates to a process for producing chemical reaction products, such as hydrogen cyanide. More particularly, the invention relates to an improved commercially advantageous process for producing hydrogen cyanide including a heat exchanger comprising a plurality of tubes through which a crude hydrogen cyanide product is passed, wherein each of the plurality of tubes comprises a ferrule extending through the entrance of the tube and the ferrule is spaced apart from the tube, e.g., does not contact the tube.

### BACKGROUND OF THE INVENTION

Conventionally, hydrogen cyanide (“HCN”) is produced on an industrial scale according to either the Andrussow process or the BMA process. (See e.g., Ullman's Encyclopedia of Industrial Chemistry, Volume A8, Weinheim 1987, pages 161-163). For example, in the Andrussow process, HCN can be commercially produced by reacting ammonia with a methane-containing gas and an oxygen-containing gas at elevated temperatures in a reactor in the presence of a suitable catalyst (U.S. Pat. Nos. 1,934,838 and 6,596,251). Sulfur compounds and higher homologues of methane may have an effect on the parameters of oxidative ammonolysis of methane. See, e.g., Trusov, Effect of Sulfur Compounds and Higher Homologues of Methane on Hydrogen Cyanide Production by the Andrussow Method, Russian J. Applied Chemistry, 74:10 (2001), pp. 1693-1697). Unreacted ammonia is separated from HCN by contacting the reactor effluent exit gas stream with an aqueous solution of ammonium phosphate in an ammonia absorber. The separated ammonia is purified and concentrated for recycle to HCN conversion. HCN is recovered from the treated reactor effluent gas stream typically by absorption into water. The recovered HCN may be treated with further refining steps to produce purified HCN. Clean Development Mechanism Project Design Document Form (CDM PDD, Version 3), 2006, schematically explains the Andrussow HCN production process. Purified HCN can be used in hydrocyanation, such as hydrocyanation of an olefin-containing group, or such as hydrocyanation of 1,3-butadiene and pentenenitrile, which can be used in the manufacture of adiponitrile (“ADN”). In the BMA process, HCN is synthesized from methane and ammonia in the substantial absence of oxygen and in the presence of a platinum catalyst, resulting in the production of HCN, hydrogen, nitrogen, residual ammonia, and residual methane (See e.g., Ullman's Encyclopedia of Industrial Chemistry, Volume A8, Weinheim 1987, pages 161-163). Commercial operators require process safety management to handle the hazardous properties of hydrogen cyanide. (See Maxwell et al. Assuring process safety in the transfer of hydrogen cyanide manufacturing technology, JHazMat 142 (2007), 677-684). Additionally, emissions of HCN production processes from production facilities may be subject to regulations, which may affect the economics of HCN manufacturing. (See Crump, Economic Impact Analysis For The Proposed Cyanide Manufacturing NESHAP, EPA, May 2000).

As HCN exits the reactor, it must be cooled prior to entering a separation train for the recovery of ammonia and HCN. One method of cooling the reactor product includes using a heat exchanger. U.S. Pat. No. 6,960,333 teaches a means for improving the service-life of indirect tube sheet type heat exchangers used in chemical reactors, particularly those exposed to reducing, nitridizing and/or carburizing environments. Such means include the use of certain ferrules within the heat exchange tubes and/or weld types used in construction of these heat exchangers. U.S. Pat. No. 6,960,333 further teaches that ceramic ferrules of silica, alumina and zirconia fail to provide adequate protection against chemical and physical agents under the harsh environments, including those of hydrogen cyanide reactors. U.S. Pat. No. 6,960,333 teaches that under these environments, the ferrules typically used, including known ceramic ferrules, are sacrificial, meaning that they degrade and must be monitored and replaced on a regular basis. U.S. Pat. No. 6,960,333 teaches that using ferrules including nickel-chromium alloy or silicon nitride greatly increases the service-life of heat tubes, particularly those used in hydrogen cyanide production.

Existing ferrules and processes for producing hydrogen cyanide using heat exchanger tubes comprising ferrules suffer from a variety of issues impeding commercial viability including: sacrificial ferrules with insufficient ferrule life, ferrules which are possibly prohibitively expensive, and decreases in process efficiency and productivity for processes for producing hydrogen cyanide using ferrules with the above impediments.

### SUMMARY OF THE INVENTION

In a first embodiment, the present invention is directed to a reaction apparatus for producing hydrogen cyanide comprising a reactor; and a heat exchanger comprising a plurality of tubes, wherein each of the plurality of tubes comprises a ferrule comprising at least 90 wt. % alumina extending through the entrance of the tube, and each ferrule comprising an insulation layer surrounding a portion of the ferrule, and one or more ceramic washers comprising at least 90 wt. % alumina, wherein at least one of the one or more washers surrounds the ferrule above the entrance of the tube, wherein the ceramic ferrule is spaced apart from the tube. The one or more washers may comprise at least 94 wt. % alumina. The ferrule may have a conical, tapered, or flared entrance portion. The ferrule may be free of silicon nitride and nickel-chromium alloy. The one or more washers may comprise from 90 to 98 wt. % alumina. The ferrule may have a lifetime of at least 6 months when exposed to hydrogen cyanide.

In a second embodiment, the present invention is directed to a reaction apparatus for producing hydrogen cyanide comprising a reactor; and a heat exchanger comprising a plurality of tubes, wherein each of the plurality of tubes comprises a ceramic ferrule comprising at least 90 wt. % alumina extending through the entrance of the tube, and each ferrule comprising an insulation layer surrounding a portion of the ferrule, and one or more ceramic washers comprising at least 90 wt. % alumina, wherein at least one of the one or more washers surrounds the ferrule above the entrance of the tube, wherein the ceramic ferrule is spaced apart from the tube; and further wherein the ceramic ferrule is free of silicon nitride and nickel-chromium alloy. The ceramic ferrule may comprise at least 94 wt. % alumina. The one or more ceramic washers may comprise a ceramic selected from the group consisting of alumina, silica, zirconia, and combinations thereof. The one or more ceramic washers may comprise at least 94 wt. % alumina.

In a third embodiment, the present invention is directed to a heat exchanger for cooling a crude hydrogen cyanide product comprising a plurality of tubes, wherein each tube comprises a ceramic ferrule comprising at least 90 wt. % alumina, wherein the ceramic ferrule is surrounded by an insulation layer and one or more ceramic washers comprising at least 90 wt. % alumina, wherein the ceramic ferrule is spaced apart from the tube, and wherein the ferrule is resistant to cracking and degradation for at least 6 months when exposed to the crude hydrogen cyanide product. The ceramic ferrule and the one or more washers may each comprise at least 94 wt. % alumina. The ceramic ferrule may extend above an upper surface of a tube sheet, and an upper portion of each tube may be attached to a lower surface of the tube sheet. The washer may surround at least a portion of the ceramic ferrule above the upper surface of the tube sheet, and the washer may abut the upper surface of the tube sheet.

In a fourth embodiment, the present invention is directed to a heat exchanger for cooling a chemical reaction product comprising a plurality of tubes, wherein each tube comprises a ceramic ferrule comprising at least 90 wt. % alumina surrounded by an insulation layer and one or more ceramic washers comprising at least 90 wt. % alumina, wherein the ceramic ferrule is spaced apart from the tube, and wherein the ceramic ferrule is resistant to cracking and degradation for at least 6 months when exposed to the chemical reaction product. The chemical reaction product may comprise crude hydrogen cyanide. The one or more washers may comprise from 90 to 98 wt. % alumina.

In a fifth embodiment, the present invention is directed to a process for producing hydrogen cyanide comprising: reacting a ternary gas mixture comprising at least 25 vol. % oxygen in a reactor to form a crude hydrogen cyanide product; passing the crude hydrogen cyanide product through a heat exchanger comprising a plurality of tubes; and recovering hydrogen cyanide from the crude hydrogen cyanide product; wherein each of the plurality of tubes comprises a ceramic ferrule comprising at least 90 wt. % alumina extending through the entrance of the tube, each ferrule comprising an insulation layer surrounding at least a portion of the ferrule, and one or more ceramic washers comprising at least 90 wt. % alumina, wherein at least one of the one or more washers surrounds the ferrule above the entrance of the tube, wherein the ceramic ferrule is spaced apart from the tube. The one or more washers may be ceramic fiber washers. The ternary gas mixture may comprise 25 to 32 vol. % oxygen and may be formed by combining a methane-containing gas, an ammonia-containing gas, and an oxygen-containing gas, wherein the oxygen-containing gas comprises at least 80 vol. % oxygen or pure oxygen. The crude hydrogen cyanide product may comprise from 20 to 50 vol % hydrogen. The ceramic ferrule may be free of silicon nitride and nickel-chromium alloy. The ceramic ferrule may comprise at least 94 wt. % alumina and the one or more washers may comprise at least 94 wt. % alumina. The ferrule may extend above the tube. The ferrule has a lifetime of at least 6 months or at least one year when exposed to the crude hydrogen cyanide product. The reaction conditions may include a temperature from 1000 to 1400° C., e.g., from 1000 to 1200° C. and the crude hydrogen cyanide product may cooled in the tube to a temperature of less than 300° C.

### BRIEF DESCRIPTION OF THE DRAWING

FIG. 1 is a simplified schematic representation, partially in cross-section, of the reaction assembly and heat exchanger as set forth in an embodiment of the present invention.

FIG. 2 is a simplified diagram of a heat exchanger tube and a ferrule that is partially wrapped in insulation according to an embodiment of the present invention.

FIG. 3 is a simplified diagram of a heat exchanger tube and a ferrule that is completely wrapped in insulation according to an embodiment of the present invention.

FIG. 4 is a simplified diagram of a heat exchanger tube and a ferrule that is partially wrapped in insulation according to another embodiment of the present invention.

FIG. 5 is a simplified diagram of a heat exchanger tube and a ferrule that is partially wrapped in insulation according to another embodiment of the present invention.

### DETAILED DESCRIPTION OF THE INVENTION

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, group of elements, components, and/or groups thereof.

Language such as “including,” “comprising,” “having,” “containing,” or “involving,” and variations thereof, is intended to be broad and encompass the subject matter listed thereafter, as well as equivalents, and additional subject matter not recited. Further, whenever a composition, a group of elements, process or method steps, or any other expression is preceded by the transitional phrase “comprising,” “including,” or “containing,” it is understood that it is also contemplated herein the same composition, group of elements, process or method steps or any other expression with transitional phrases “consisting essentially of,” “consisting of,” or “selected from the group of consisting of,” preceding the recitation of the composition, the group of elements, process or method steps or any other expression.

The corresponding structures, materials, acts, and equivalents of all means or step plus function elements in the claims, if applicable, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments described herein were chosen and described in order to best explain the principles of the invention and the practical application, and to enable others of ordinary skill in the art to understand the invention for various embodiments with various modifications as are suited to the particular use contemplated. Accordingly, while the invention has been described in terms of embodiments, those of skill in the art will recognize that the invention can be practiced with modifications and in the spirit and scope of the appended claims.

Reference will now be made in detail to certain disclosed subject matter. While the disclosed subject matter will be described in conjunction with the enumerated claims, it will be understood that they are not intended to limit the disclosed subject matter to those claims. On the contrary, the disclosed subject matter is intended to cover all alternatives, modifications, and equivalents, which can be included within the scope of the presently disclosed subject matter as defined by the claims.

Conventionally, hydrogen cyanide (“HCN”) is produced on an industrial scale according to either the Andrussow process or by the BMA process. In the Andrussow process, methane, ammonia and oxygen-containing feed stocks are reacted at temperatures above 1000° C. in the presence of a catalyst to produce a crude hydrogen cyanide product comprising HCN, hydrogen, carbon monoxide, carbon dioxide, nitrogen, residual ammonia, residual methane, and water. In some preferred embodiments, the methane-, ammonia- and oxygen-containing feedstocks are combined to form a ternary gas mixture prior to being reacted in the presence of the catalyst to form the crude hydrogen cyanide, product. Prior to passing through a heat exchanger, the crude hydrogen cyanide product is at a temperature above 1000° C. and must be cooled prior to further processing.

The formation of HCN in the Andrussow process is often represented by the following generalized reaction:

2CH₄+2NH₃+3O₂→2HCN+6H₂O

However, it is understood that the above reaction represents a simplification of a much more complicated kinetic sequence where a portion of the hydrocarbon is first oxidized to produce the thermal energy necessary to support the endothermic synthesis of HCN from the remaining hydrocarbon and ammonia.

Three basic side reactions also occur during the synthesis of HCN:

CH₄+H₂O→CO+3H₂

2CH₄+3O₂→2CO+4H₂O

4NH₃+3O₂→2N₂+6H₂O

In addition to the amount of nitrogen generated in the side reactions, additional nitrogen may be present in the crude product, depending on the source of oxygen. Although the prior art has suggested that oxygen-enriched air or pure oxygen can be used as the source of oxygen, the advantages of using oxygen-enriched air or pure oxygen have not been fully explored. When using air as the source of oxygen, the crude hydrogen cyanide product comprises the components of air, e.g., 78 vol. % nitrogen, and the nitrogen produced in the ammonia and oxygen side reactions.

The term “air” as used herein refers to a mixture of gases with a composition approximately identical to the native composition of gases taken from the atmosphere, generally at ground level. In some examples, air is taken from the ambient surroundings. Air has a composition that includes approximately 78 vol. % nitrogen, 21 vol. % oxygen, 1 vol. % argon, and 0.04 vol. % carbon dioxide, as well as small amounts of other gases.

The term “oxygen-enriched air” as used herein refers to a mixture of gases with a composition comprising more oxygen than is present in air. Oxygen-enriched air has a composition including greater than 21 vol. % oxygen, less than 78 vol. % nitrogen, less than 1 vol. % argon and less than 0.04 vol. % carbon dioxide. In some embodiments, the oxygen content in the oxygen-containing gas is at least 28 vol. % oxygen, at least 80 vol. % oxygen, at least 95 vol. % oxygen, or at least 99 vol. % oxygen.

Due to the large amount of nitrogen in air, it is advantageous to use oxygen-enriched air in the synthesis of HCN because the use of air as the source of oxygen in the production of HCN results in the synthesis being performed in the presence of a larger volume of inert gas (nitrogen) necessitating the use of larger equipment in the synthesis step and resulting in a lower concentration of HCN in the product gas. Additionally, because of the presence of the inert nitrogen, more methane is required to be combusted in order to raise the temperature of the ternary gas mixture components to a temperature at which HCN synthesis can be sustained. The crude hydrogen cyanide product contains the HCN and also by-product hydrogen, methane combustion byproducts (carbon monoxide, carbon dioxide, water), residual methane, and residual ammonia. However, when using air (i.e., 21 vol. % oxygen), after separation of the HCN and recoverable ammonia from the other gaseous components, the presence of the inert nitrogen renders the residual gaseous stream with a fuel value that may be lower than desirable for energy recovery.

Therefore, the use of oxygen-enriched air or pure oxygen instead of air in the production of HCN provides several benefits, including the ability to recover hydrogen. Additional benefits include an increase in the conversion of natural gas to HCN and a concomitant reduction in the size of process equipment. Thus, the use of oxygen-enriched air or pure oxygen reduces the size of the reactor and at least one component of the downstream gas handling equipment through the reduction of inert compounds entering the synthesis process. The use of oxygen-enriched air or pure oxygen also reduces the energy consumption required to heat the oxygen-containing feed gas to reaction temperature. The ternary gas mixture may have a molar ratio of ammonia-to-oxygen from 1.2 to 1.6, e.g., from 1.3 to 1.5, a molar ratio of ammonia-to-methane from 1 to 1.5, e.g., from 1.10 to 1.45, and a molar ratio of methane-to-oxygen of 1 to 1.25, e.g., from 1.05 to 1.15. For example, a ternary gas mixture may have a molar ratio of ammonia-to-oxygen of 1.3 and methane-to-oxygen 1.2. In another exemplary embodiment, the ternary gas mixture may have a molar ratio of ammonia-to-oxygen of 1.5 and methane-to-oxygen of 1.15. The oxygen concentration in the ternary gas mixture may vary depending on these molar ratios. In some embodiments, the ternary gas mixture comprises at least 25 vol. % oxygen, e.g., at least 28 vol. % oxygen. In some embodiments, the ternary gas mixture comprises from 25 to 32 vol. % oxygen, e.g., from 26 to 30 vol. % oxygen. Exemplary crude hydrogen cyanide product compositions are shown below in Table 1.

TABLE 1
CRUDE HYDROGEN CYANIDE PRODUCT COMPOSITIONS

| | Oxygen | Air Andrussow |
|---|---|---|
| | Andrussow | Process |
| Nominal Composition, vol.%: | Process | (Ullmann's) |
| H₂ | 34.5 | 13.3 |
| N₂ | 2.4 | 49.2 |
| CO | 4.7 | 3.8 |
| Ar | 0.1 | |
| CH₄ | 0.8 | 0.3 |
| CO₂ | 0.4 | 0.4 |
| NH₃ | 6.6 | 2.3 |
| HCN | 16.9 | 7.6 |
| Other nitriles | <0.1 | ** |
| H₂O | 33.4 | 23.1 |

As is shown in Table 1, preparing HCN using the air process only produces 13.3 vol. % hydrogen, while the oxygen process results in increased hydrogen of 34.5 vol. %. The amount of hydrogen may vary depending on oxygen concentration of the feed gases and ratios of reactants, and may range from 34 to 36 vol. % hydrogen. Without being bound by theory, it is believed that this increased amount of hydrogen increases the sensitivity of the ferrule to degradation, as is further described herein.

In addition to Table 1, oxygen concentration of the crude hydrogen cyanide product is low, preferably less than 0.5 vol. %, and higher amounts of oxygen in the crude hydrogen cyanide product may trigger shut down events or necessitate purging. Depending on the molar ratios of ammonia, oxygen and methane used, the crude hydrogen cyanide product formed using the Oxygen Andrussow Process may vary as shown in Table 2.

TABLE 2
CRUDE HYDROGEN CYANIDE PRODUCT COMPOSITIONS
USING OXYGEN ANDRUSSOW PROCESS

| | Vol. % | Vol. % |
|---|---|---|
| H₂ | 20 to 50 | 30 to 40 |
| N₂ | 1 to 5 | 1 to 4 |
| CO | 0.5 to 10 | 1 to 5 |
| Ar | 0.01 to 1 | 0.05 to 0.5 |
| CH₄ | 0.05 to 1 | 0.1 to 1 |
| CO₂ | 0.01 to 3 | 0.1 to 0.5 |
| NH₃ | 5 to 15 | 5 to 10 |
| HCN | 12 to 20 | 14 to 18 |
| Other nitriles | <0.1 | ** |
| H₂O | 25 to 50 | 30 to 40 |

To prevent decomposition of HCN and unreacted ammonia, the crude hydrogen cyanide product leaving the reactor must be quickly quenched, for example, to less than 300° C., such as 250° C. or less. The crude hydrogen cyanide product may be quenched using a heat exchanger, e.g., waste heat boiler, comprising a plurality of tubes, each of which is connected to a tube sheet. Material of construction of the tube sheet and the tubes of the heat exchanger should be selected from materials having low activity for the decomposition of HCN, e.g. HCN hydrolysis. Carbon steel has been found to be a low cost favorable choice for the tube sheet and tubes. The cooled crude hydrogen cyanide product can then be sequentially passed from the waste heat boiler, to a gas cooler, to an ammonia recovery section, and to an HCN refining section. The inlet temperature of boiler feed water, to the waste heat boiler must be sufficiently high to prevent condensation of the cooled crude hydrogen cyanide product.

The waste heat boiler both cools the crude hydrogen cyanide product and recovers the heat of reaction (i.e., combustion) produced during the conversion of the ternary gas mixture into HCN. The heat recovered by the waste heat boiler can be used to generate pressurized steam and/or to preheat the ternary gas mixture. In one embodiment, the waste heat boiler is a natural circulation heat exchanger used to generate steam, and a 2-phase water/steam mixture is removed at multiple points along a circumference near an uppermost portion of the waste heat boiler through steam riser tubes to a steam drum. Steam is disengaged in the steam drum and the remaining condensate is returned to the waste heat boiler. When the recovered heat is used to preheat the ternary gas mixture, the amount of the gas feed streams consumed during synthesis in the reactor can be reduced, and the yield of HCN, based upon each of the gas feed streams, is increased significantly.

The waste heat boiler may be a shell and tube heat exchanger comprising a plurality of tubes surrounded by boiler feed water, e.g., boiling water. The water surrounding the tubes is present at a lower temperature than the temperature of the crude hydrogen cyanide product and serves to maintain a tube temperature that is less than the temperature of the crude hydrogen cyanide product, e.g., less than 315° C., or less than 250° C. Because of the harsh environments of hydrogen cyanide reactors, and thus of the crude hydrogen cyanide product, the waste heat boiler tubes are susceptible to cracking, requiring increased maintenance and replacement and leading to decreased process efficiency. The waste heat boiler tubes may experience increased cracking as the oxygen content in the ternary gas mixture increases, which causes an increase in the hydrogen concentration of the crude hydrogen cyanide product. One solution is to insulate at least a portion of the waste heat boiler tubes from contact with the crude hydrogen cyanide product. Preferably, a top portion of the tube is insulated to protect the tube from the high temperature ternary gas mixture. Although the tubes are surrounded by boiler feed water, the tube sheet and top of the tubes may not be sufficiently cooled by this water. To insulate the waste heat boiler tubes, each tube may comprise a ferrule. The ferrule may be made from a ceramic material. However, even the ferrules, when in contact with the waste heat boiler tubes or the waste heat boiler tube sheet, may experience cracking due to the high temperature and harsh environment of the crude hydrogen cyanide product. Ferrules in the prior art mainly comprise silicon and/or oxides thereof, which is reactive with the hydrogen in the crude hydrogen cyanide product. For example, these prior art ferrules may have silicon and/or oxides thereof present in concentrations above 40 wt. %. Thus, as the oxygen-content in the ternary gas mixtures increases, the increase in hydrogen content in the crude hydrogen cyanide product may lead to reduced ferrule life.

Surprisingly and unexpectedly, it has been found that when the ferrule is comprised of a high alumina ceramic and is surrounded by one or more ceramic washers, e.g., high alumina ceramic washers, the lifetime of the ferrule is increased. Insulating the ferrule may also advantageously increase lifetime performance and prevent cracking of the ferrule. The washers are configured to separate the ferrule from the waste heat boiler tube sheet and from the waste heat boiler tube. The washers may also be used to position the ferrule in such a position so that the ferrule is spaced apart from the tube sheet and tube. Without being bound by theory, it is believed that this increased lifetime is due to the reduced thermal stress due to the spaced apart position of the ferrule from the waste heat boiler tube sheet and tubes. This spaced apart position may reduce material degradation of the alumina containing ferrule and/or washer.

The ferrule is comprised of ceramic and the ceramic may comprise at least 90 wt. % alumina, e.g., at least 94 wt. % alumina and at least 98 wt. % alumina. In terms of ranges, the ferrule may comprise from 90 to 98 wt. % alumina, e.g., from 92 to 98 wt. % alumina, or from 93 to 95 wt. % alumina. The ferrule may additionally comprise silicon and/or oxides thereof, zirconia, and combinations thereof. However, the loading of silicon and or oxides is preferably low. In one aspect, the loading of silicon and or oxides in the ferrule may be less than 10 wt. %, e.g., less than 8 wt. %, or less than 6 wt. %. The weight ratio of alumina to silica in the ferrule may be from 9:1 to 200:1, e.g., from 15:1 to 100:1. An exemplary ferrule may comprise 94 wt. % alumina and 6 wt. % silica. In one aspect, the ceramic ferrules are made of a single piece of ceramic. Without being bound by theory, it is believed that using a single piece of ceramic, free of seams, helps prevent cracking of the ferrule due to thermal expansion.

The one or more washers are also ceramic and may have a similar composition as the ferrule. In one aspect, the one or more washers comprise at least 90 wt. % alumina, e.g., at least 94 wt. % alumina and at least 98 wt. % alumina. In terms of ranges, the washer may comprise from 90 to 98 wt. % alumina, e.g., from 92 to 98 wt. % alumina, or from 93 to 95 wt. % alumina. The ceramic washer may also comprise silicon and/or oxides thereof, zirconia, and combinations thereof. In one aspect, the loading of silicon and or oxides in the washer may be less than 10 wt. %, e.g., less than 8 wt. % or less than 6 wt. %. An exemplary washer may comprise 94 wt. % alumina and 6 wt. % silica. The washer may be a ceramic fiber washer. Without being bound by theory, it is believed that using a ceramic fiber washer reduces the brittleness of the washer because it is sufficiently flexible. This fiber allows for slight movement of the washer during reactor operation.

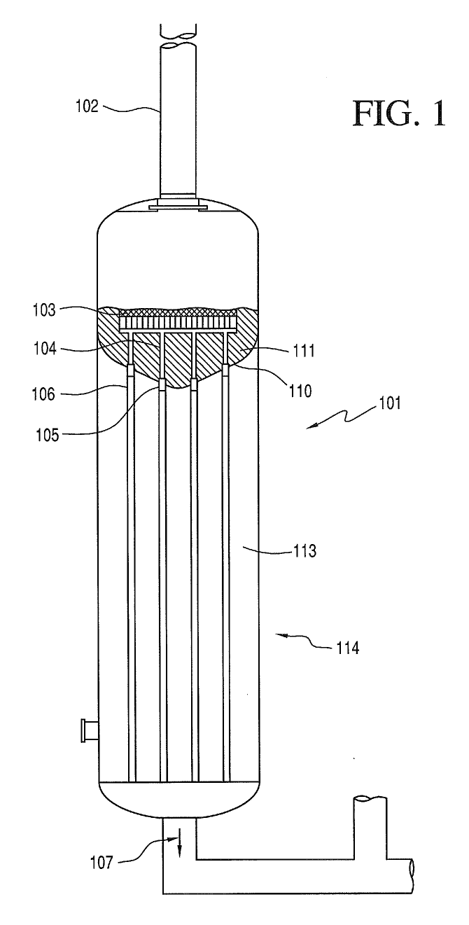

FIG. 1 illustrates reaction apparatus 101. The reaction apparatus contains a reaction section which is mated to a heat exchanger, e.g., waste heat boiler 114. The ternary gas mixture is fed to the reactor via line 102, contacts the catalyst bed 103 and reacts to form the crude hydrogen cyanide product. The ternary gas mixture may be obtained by mixing a methane-containing gas, ammonia-containing gas, and either pure oxygen or oxygen-enriched air. The crude hydrogen cyanide product then passes through a waste heat boiler 114 which comprises a plurality of tubes 106 through which the crude hydrogen cyanide product flows to cool the crude hydrogen cyanide product and to generate steam on the shell side of the waste heat boiler 114. The number of tubes 106 may vary depending on the size of the reactor. The shell side of the waste heat boiler 114 is isolated from the reactor by a tube sheet 110 to which the tops of the tubes 106 are welded. Tube sheet 110 may be flat or may be conically shaped as shown in FIG. 1. The section of the reactor directly above the tube sheet 110 is a castable ceramic material 111 which contains a plurality of holes that are mated with the tubes 106 of the waste heat boiler. The holes in the castable 111 are connected to tubes 106 in the waste heat boiler 114 using ceramic ferrules 105 that fit into tubes 106. Additionally, ceramic ferrules 105 are connected to reactor outlets 104 by the holes. As is shown in FIGS. 1-5, each tube 106 comprises a ceramic ferrule 105. The tubes 106 are surrounded by boiler feed water 113. The bottom surface of tube sheet 110 may also be in contact with boiler feed water 113. As the crude hydrogen cyanide product passes through the waste heat boiler 114, it is cooled to a temperature of less than 300° C., e.g. less than 275° C. or less than 250° C., and exits the reactor via line 107, where it may be further processed.

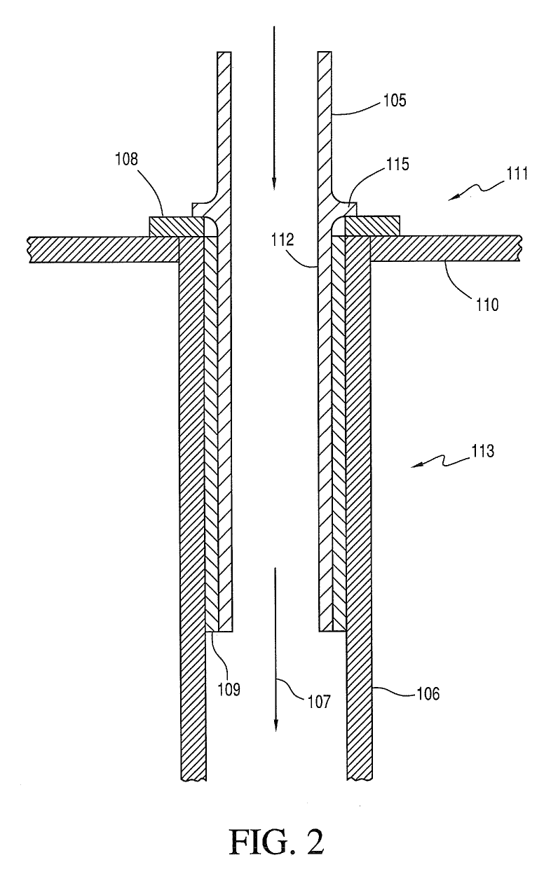

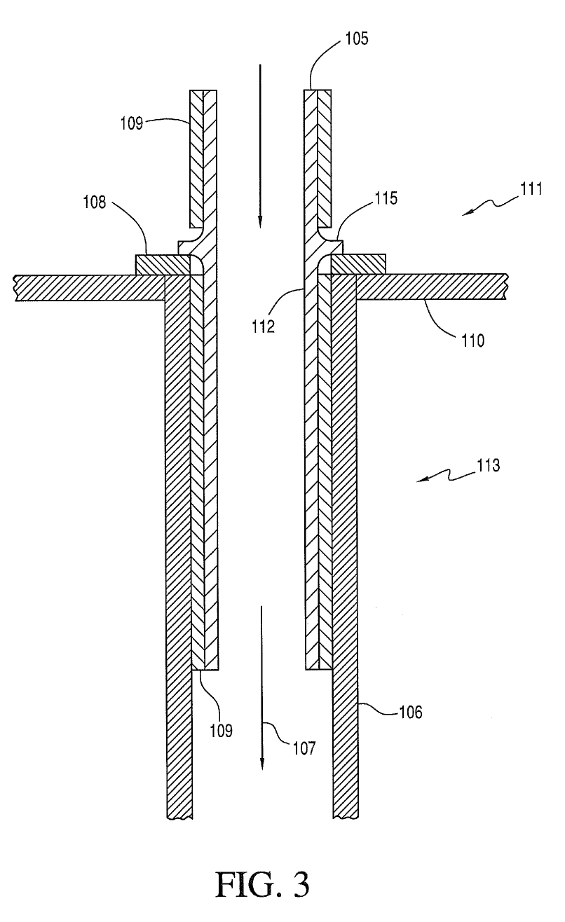

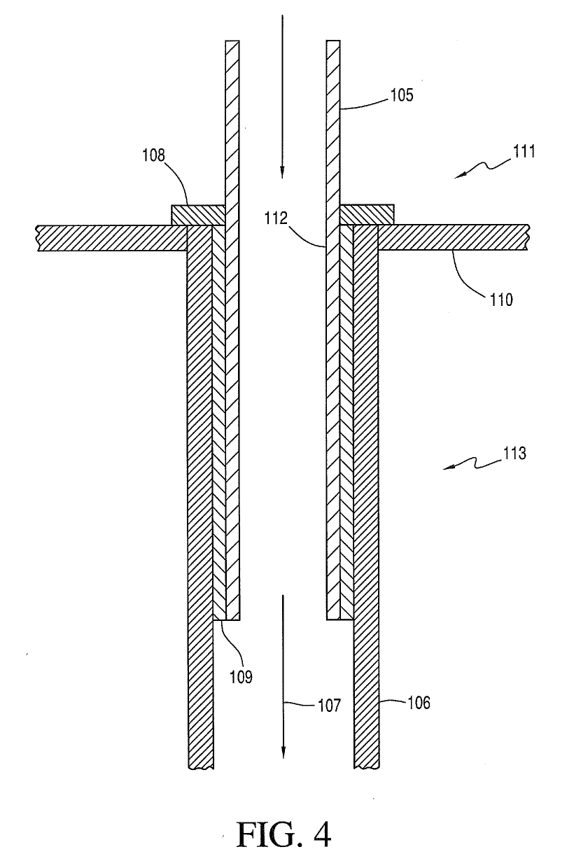

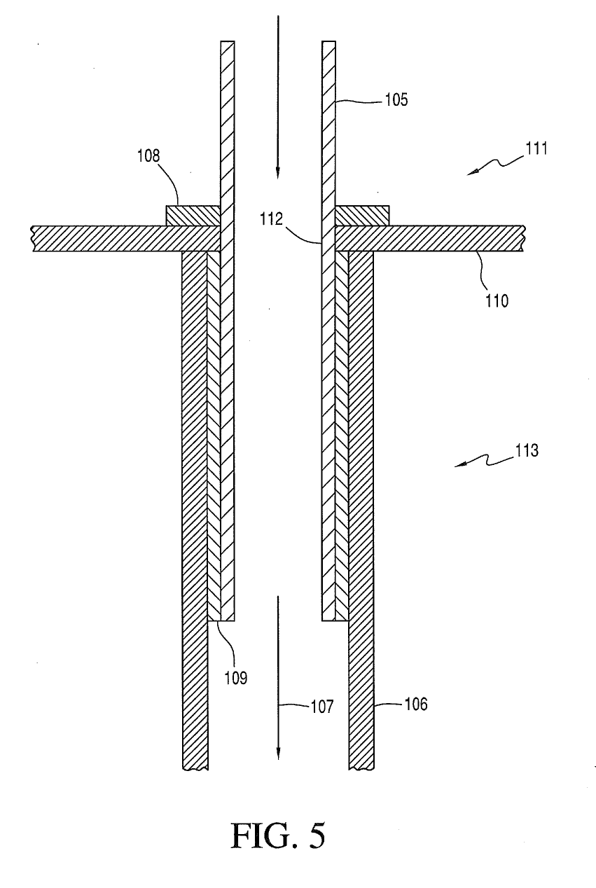

Before inserting ferrule 105 into tube 106, a washer 108 is placed over the tube sheet 110. As shown in FIGS. 2 and 3, in one embodiment, a protrusion 115 in ferrule 105 may isolate ferrule 105 from direct contact with tube sheet 110 and tubes 106. The protrusion 115 may be shaped to prevent the ferrule 105 from slipping through the washer 108. Although one protrusion is shown, multiple protrusions may be used without limitation. Without being bound by theory, it is believed that by including a protrusion 115 in the ferrule 105, ferrule lifetime may be increased even if the ferrule 105 is subject to some degradation. In other embodiments, as shown in FIGS. 4 and 5, ferrule 105 may be used without a protrusion 115. Once the ferrules 105 are inserted into the tubes 106, lubricated dowels with tapered ends are inserted into the top of the ferrules. The dowels may be comprised of wood, polytetrafluoroethylene, and other materials sufficient to block the flow of ceramic cement that forms the castable material 111. For convenience, the location of the castable material 111 in FIGS. 2-5 is shown and it should be understood that the castable material 111 completely covers tube sheet 110 and surrounds each ferrule 105 as shown in FIG. 1. Once the dowels are in place, ceramic cement is poured onto the tube sheet 110 to form the bottom part of the reactor. After the cement hardens, the dowels are removed from the ceramic cast to form the holes through which the gas passes. The dowels may be relubricated and reinserted. Multiple layers of castable material may be cast in a similar manner. In one embodiment, the castable material used to cast the second layer may be comprised of a different material than the first layer, e.g., a material that is more resistant to abrasion and mechanical stress. The dowels are again removed after the ceramic cement hardens. The catalyst support is then placed on top of the castable, and a third pour of castable is made to form a seal between the catalyst support and the reactor wall. The catalyst 103 is then placed over the catalyst support. The reactor internals above the catalyst are not shown in FIG. 1 for convenience.

Tube 106 is connected to castable ceramic material 111 using ceramic ferrule 105. Ceramic ferrule 105 is spaced apart from tube sheet 110 by washer 108, to prevent ceramic ferrule 105 from contacting tube sheet 110 and tube 106. Washer 108 is securely fitted around ceramic ferrule 105 to prevent ceramic ferrule 105 from passing into tube 106. Washer 108 surrounds ceramic ferrule 105 above the tube sheet 110 and has an outer diameter that is larger than the tube 106. Washer 108 abuts the upper surface of tube sheet 110, to which tube 106 is welded. In some aspects, washer 108 is not glued or otherwise adhered to tube sheet 110. In these aspects, the pouring of tastable material 111 serves to maintain the placement of washer 108. Although one washer is shown in FIGS. 2-5, multiple washers may be used.

Ceramic ferrule 105 has a length that is less than tube 106. Each tube 106 may have a length of several meters, while the ceramic ferrules may have a length of less than 20 cm. Ceramic ferrule 105 extends above tube sheet 110 by at least 1 cm, e.g., at least 3 cm, or at least 5 cm. In addition, ceramic ferrule 105 may extend below tube sheet 110 by at least 5 cm, e.g., at least 8 cm, or at least 10 cm. It is preferably that a majority of ferrule 105 is within tube 106. In one embodiment, the length of ceramic ferrule 105 is sufficient to extend below the level of the boiler feed water 113. For convenience, the location of the boiler feed water 113 in FIGS. 2-5 is shown and it should be understood that the boiler feed water 113 surrounds tube 106 as shown in FIG. 1 and may contact the tube sheet 110.

At least a portion of ceramic ferrule 105 may be wrapped in an insulating material 109, such as a suitable inorganic insulating paper. Exemplary inorganic insulating papers are sold by 3M Company under the tradenames 3M™ CeQUIN and 3M™ ThermaVolt. Insulating material 109 may surround a portion of the ceramic ferrule 105 that is within tube 106, as shown in FIG. 2. In another embodiment, insulating material 109 may surround the entire length of ceramic ferrule 105, as shown in FIG. 3. The thickness of insulating material 109 is preferably uniform, i.e., does not vary by more than 0.5 cm, and may range from 0.05 cm to 0.2 cm. The insulating material may be further compressed prior to use. In one embodiment, insulating material 109 separates tube 106 from ferrule 105 and contacts inner surface of tube 106, as shown in FIG. 2. Preferably there is no space between insulating material 109 and tube 106 and thus there is a sealing fit between ferrule 105 and tube 106. Insulating material 109 spaces ferrule 105 away from the inner surface of tube 106. This prevents further degradation of ferrule 105.

As shown in FIGS. 2-5, ceramic ferrule 105 may have parallel internal walls. The thickness of the ferrule may be varied over the length of the ferrule. For example, the walls of ferrule 105 may be thicker above washer 108 than below washer 108. Without being bound by theory, it is believed that thicker ferrule walls above the washer increase the strength of the ferrule while thinner walls below washer 108 result in an increased internal diameter and thus more capacity through the ferrule. Also, the thicker upper wall may prevent ferrule 105 from passing into tube 106. In other aspects, ceramic ferrule 105 may be, for example, shaped as a cylindrical tube with a conical, tapered or flared entrance portion (not shown), which fits inside the entrance 112 of each of the plurality of waste heat boiler tubes 106 such that the ceramic ferrule 105 is spaced apart from the inner surface of tube 106 by the one or more washers 108. The conical, tapered or flared entrance portion may also prevent ferrule 105 from passing into tube 106. For example, the conical, tapered or flared entrance portion may have a diameter that is larger than entrance 112. Washers 108 of the present invention may be shaped to securely fit around and surround the circumference of the ferrule and may be flat ribbons wound around the ferrule. The washers preferably comprise at least 90 wt. % alumina, for example from 90 to 98 wt. %, such as from 93 to 95 wt. % alumina.

As shown in FIG. 5, entrance 112 may have a diameter that is smaller than the diameter of tube 106. Tube sheet 110 may extend past the tube wall creating a ledge. In this aspect, the ceramic ferrule 105 is fitted in a position to extend through entrance 112 and into tube 106. The diameter of the ceramic ferrule is smaller than entrance 112 and thus smaller than the diameter of tube 106. As shown in FIG. 4, washer 108 may extend over tube sheet 110, or, as shown in FIG. 5, may be flush with tube sheet 110. In another aspect, entrance 112 may have a diameter that is similar to diameter of tube 106 as shown in FIGS. -4 so that tube wall is flush with the edge of tube sheet 110.

The ceramic ferrule when used as required herein has a lifetime of at least 6 months, e.g., at least 1 year, or at least 3 years when exposed to chemical reaction products, such as for example crude hydrogen cyanide product, at highly abrasive conditions, including those required for rapid quenching of hot effluent gasses and/or reducing environments. For example, in hydrogen cyanide production, hot effluent gasses comprising crude hydrogen cyanide product must be rapidly cooled from 1,000 to 1,400° C., e.g., more preferably 1,000 to 1,200° C., to less than 300° C., e.g., less than 275° C. or less than 250° C., to prevent decomposition of the HCN. Due to the high temperature of the crude hydrogen cyanide product when it first enters the waste heat boiler, and thus before it contacts the lower temperature tubes, the ferrules are exposed to harsher conditions,

In some embodiments, the ferrules and washers may each comprise at least 90 wt. % alumina. In one aspect, the alumina for the ferrules and the washers may be alpha alumina. The amount of alumina preferred in the ferrules and washers is a function of the amount of oxygen present in the ternary gas mixture. As described herein, as the amount of oxygen increases above the amount naturally found in air, the more sensitive the ferrule becomes to the crude hydrogen cyanide product. In particular, the hydrogen in the crude hydrogen cyanide product may react with silicon and/or oxides thereof, leading to degradation of materials containing high amounts of silicon and/or oxides thereof. If more than 10 wt. % silicon and/or oxides thereof is present in the ferrules and washers, the ferrules and washers may become sacrificial and have reduced lifetimes. This requires frequent changing of ferrules which is expensive and requires the reactor to be off-line. Because high oxygen content in the ternary gas mixture is preferred, it is necessary to limit the amount of silicon and/or oxides thereof in the ferrules and washers. Hence, the silicon and/or oxides thereof content in the ferrules and washers should be less than 10 wt. %, e.g., from 0.01 to 5 wt. %. It may be advantageous to use oxygen-enriched air or pure oxygen as the oxygen-containing gas. Therefore, in some embodiments, the ceramic ferrule and one or more washers comprise less than 10 wt. % silicon and/or oxides thereof, e.g., less than 7.5 wt. % or less than 5 wt. % silicon and/or oxides thereof.

Various control systems may be used to regulate the reactant gas flow. For example, flow meters that measure the flow rate, temperature, and pressure of the reactant gas feed streams and allow a control system to provide “real time” feedback of pressure- and temperature-compensated flow rates to operators and/or control devices may be used. As will be appreciated by one skilled in the art, the foregoing functions and/or process may be embodied as a system, method or computer program product. For example, the functions and/or process may be implemented as computer-executable program instructions recorded in a computer-readable storage device that, when retrieved and executed by a computer processor, controls the computing system to perform the functions and/or process of embodiments described herein. In one embodiment, the computer system can include one or more central processing units, computer memories (e.g., read-only memory, random access memory), and data storage devices (e.g., a hard disk drive). The computer-executable instructions can be encoded using any suitable computer programming language (e.g., C++, JAVA, etc.). Accordingly, aspects of the present invention may take the form of an entirely software embodiment (including firmware, resident software, micro-code, etc.) or an embodiment combining software and hardware aspects.

From the above description, it is clear that the present invention is well adapted to carry out the objects and to attain the advantages mentioned herein as well as those inherent in the presently provided disclosure. While preferred embodiments of the present invention have been described for purposes of this disclosure, it will be understood that changes may be made which will readily suggest themselves to those skilled in the art and which are accomplished within the spirit of the present invention.

In order to demonstrate the present process, the following examples are given. It is to be understood that the examples are for illustrative purposes only and not to be construed as limiting the scope of the invention.

### Example 1

A ternary gas mixture is formed by combining pure oxygen, an ammonia-containing gas and a methane-containing gas. The ammonia-to-oxygen molar ratio in the ternary gas mixture is 1.3:1 and the methane-to-oxygen molar ratio in the ternary gas mixture is from 1.2:1 The ternary gas mixture, which comprises from 27 to 29.5 vol. % oxygen, is reacted in the presence of a platinum/rhodium catalyst to form a crude hydrogen cyanide product. Hydrogen forms during the reaction and the crude hydrogen cyanide product comprises 34.5 vol. % hydrogen. The waste heat boiler comprises a carbon steel tube sheet and 392 carbon steel waste heat boiler tubes. Each tube is surrounded by boiling water. Each tube comprises a ferrule that comprises 94 wt. % alumina and 6 wt. % silica. Each waste heat boiler tube has a length of 914.4 cm and the ferrule has a length of 17.8 cm. The ferrule extends through the entrance of the tube such that a portion of the ferrule extends 5.01 cm above the entrance of the waste heat boiler tube and extends 12.7 cm into the waste heat boiler tube, i.e. below the entrance. The ferrule is spaced apart from the waste heat boiler tube by a layer of paper compressed ceramic fiber wrap insulation with a uniform thickness of 0.1 cm. The insulation surrounds the entire length of the ferrule. A ceramic washer comprising 94 wt. % alumina and 6 wt. % silica surrounds the insulated ferrule. The crude hydrogen cyanide product is at a temperature of 1150° C. when it enters the ferrule and is cooled to 230° C. when it exits the waste heat boiler tube. Under continuous operation conditions, the ferrules have a service life from 4 to 5 years.

### Example 2

A crude hydrogen cyanide product is prepared and cooled as in Example 1, using the same ferrule and insulation of Example 1, except that no washer is used. The ferrules have a service life of 2 years.

### Comparative Example A

A crude hydrogen cyanide product is prepared and cooled as in Example 1, except that no insulation is used to keep the ferrule from contacting the heat exchange tube. The ferrules have a service life of less than 6 months and many of the ferrules are sacrificed on reaction start-up.

### Comparative Example B

A crude hydrogen cyanide product is prepared and cooled as in Example 1, except that the ferrule is comprised of silicon nitride. The ferrules have a service life of less than 6 months and many of the ferrules are sacrificed on reaction start-up. The reactor is taken off-line for two weeks to replace the ferrules, resulting in increased costs and reduced HCN yield.

### Comparative Example C

A crude hydrogen cyanide product is prepared and cooled as in Example 1, except that the ferrule is comprised of 50 wt. % alumina and 50 wt. % silica. As shown in Table 1, the hydrogen content in the crude hydrogen cyanide product is higher when using pure oxygen rather than air as the oxygen-containing gas. The hydrogen in the crude hydrogen cyanide product reacts with the silica in the ferrules and the ferrules degrade. The ferrules have a service life of less than 6 months and many of the ferrules are sacrificed on reaction start-up. The reactor is taken off-line for two weeks to replace the ferrules, resulting in increased costs and reduced HCN yield.

### Comparative Example D

A crude hydrogen cyanide product is prepared and cooled as in Example 1, except that the ferrule is comprised of a nickel-chromium alloy. The nickel-chromium alloy is conductive and would react with the crude hydrogen cyanide product. The ferrules have a service life of less than 3 months and many of the ferrules are sacrificed on reaction start-up. The reactor is taken off-line for two weeks to replace the ferrules, resulting in increased costs and reduced HCN yield.

### Comparative Example E

A crude hydrogen cyanide product is prepared and cooled as in Example 1, except that the washer is comprised of silicon nitride. The washer degrades and the ferrules have a service life of less than 6 months. Many of the ferrules are sacrificed on reaction start-up. Additionally, as cracks appear in the washer, or as the washer is degraded, the overall reactor may be damaged if the ferrules drop into the waste heat boiler tubes. The reactor is taken off-line for at least two weeks to replace the ferrules and repair the reactor, resulting in increased costs and reduced HCN yield.

### Comparative Example F

A crude hydrogen cyanide product is prepared and cooled as in Example 1, except that the washer is comprised of 80 wt. % alumina and 20 wt. % silica. As shown in Table 1, the hydrogen content in the crude hydrogen cyanide product is higher when using pure oxygen rather than air as the oxygen-containing gas. The hydrogen in the crude hydrogen cyanide product reacts with the silica in the washer and the washer degrades. The ferrules have a service life of less than 6 months and many of the ferrules are sacrificed on reaction start-up. The reactor is taken off-line for two weeks to replace the ferrules, resulting in increased costs and reduced HCN yield.

1. A process for producing hydrogen cyanide comprising:
(a) reacting a ternary gas mixture comprising at least 25 vol. % oxygen in a reactor to form a crude hydrogen cyanide product;
(b) passing the crude hydrogen cyanide product through a heat exchanger comprising a plurality of tubes; and
(c) recovering hydrogen cyanide from the crude hydrogen cyanide product;
wherein each of the plurality of tubes comprises a ceramic ferrule comprising at least 90 wt. % alumina extending through the entrance of the tube, each ferrule comprising an insulation layer surrounding at least a portion of the ferrule, and one or more ceramic washers comprising at least 90 wt. % alumina, wherein at least one of the one or more ceramic washers surrounds the ferrule above the entrance of the tube, wherein the ceramic ferrule is spaced apart from the tube.

2. The process of claim 1, wherein the ternary gas mixture comprises from 25 to 32 vol. % oxygen.

3. The process of claim 1, wherein the ternary gas mixture is formed by combining a methane-containing gas, an ammonia-containing gas, and an oxygen-containing gas.

4. The process of claim 3, wherein the oxygen-containing gas comprises pure oxygen.

5. The process of claim 1, wherein the ceramic ferrule is free of silicon nitride and nickel-chromium alloy.

6. The process of claim 1, wherein the ceramic washer is a ceramic fiber washer.

7. The process of claim 1, wherein the ceramic ferrule comprises at least 94 wt. % alumina.

8. The process of claim 1, wherein the ceramic ferrules comprises from 90 wt. % to 98 wt. % alumina.

9. The process of claim 1, wherein the one or more washers comprise at least 94 wt. % alumina.

10. The process of claim 1, wherein the one or more washers comprise from 90 wt. % to 98 wt. % alumina.

11. The process of claim 1, wherein the ceramic ferrule comprises less than 8 wt. % silicon or oxides thereof.

12. The process of claim 1, wherein the one or more washers comprise less than 8 wt. % silicon or oxides thereof.

13. The process of claim 1, wherein the ceramic ferrule has a lifetime of at least 6 months when exposed to the crude hydrogen cyanide product, preferably at least 1 year, preferably at least 2 years.

14. The process of claim 1, wherein the crude hydrogen cyanide product comprises from 20 vol. % to 50 vol. % hydrogen.

15. The process of claim 1, wherein the reaction conditions include a temperature from 1000 to 1400° C. and wherein the crude hydrogen cyanide product is cooled in the heat exchanger to a temperature of less than 300° C.
